(19) United States
(12) Patent Application Publication
(10) Pub. No.: US 2012/0020494 A1
(43) Pub. Date: Jan. 26, 2012

(54) SIGNAL-COMPONENT EXTRACTION APPARATUS AND SIGNAL-COMPONENT EXTRACTION METHOD

(75) Inventor: Yasunori SUZUKI, Kanagawa-Ken (JP)

(73) Assignee: KABUSHIKI KAISHA KENWOOD, Tokyo-To (JP)

(21) Appl. No.: 13/159,676

(22) Filed: Jun. 14, 2011

(30) Foreign Application Priority Data
Jul. 22, 2010 (JP) JP 2010-165342

(51) Int. Cl. H04B 15/00

(52) U.S. Cl. 381/94.2

(57) ABSTRACT

In signal-component extraction, an input signal is delayed to generate a delayed input signal. The input signal is adaptively filtered with filter coefficients, to generate a filtered signal. The filtered signal is subtracted from the delayed input signal to generate an error signal. A preset reference value is divided by an amplitude of the input signal to generate a gain value. The filter coefficients are derived based on a value obtained by multiplying the input signal and error signal by the gain value or a square of the gain value.

### CROSS-REFERENCE TO RELATED APPLICATIONS

This application is based on and claims the benefit of priority from the prior Japanese Patent Application No. 2010-165342 filed on Jul. 22, 2010, the entire contents of which is incorporated herein by reference.

### BACKGROUND OF THE INVENTION

The present invention relates to a signal-component extraction apparatus and a signal-component extraction method for extracting a signal component from an input signal.

For extracting a signal having specific frequency components, it is general to use a filter that decreases frequency components except for the specific frequency components.

Among such filters, an adaptive filter is a filter that self-adjusts to a specific transfer function in accordance with a reference output signal of the transfer function, in accordance with an optimization algorithm. The adaptive filter can self-adjust to a specific transfer function by adjusting its filter coefficients any time so as to have a smaller difference (error signal) between a target desired signal and a filtered signal.

There is a known technique to extract desired audio components from a main input signal that carries the audio components and noise components. The known technique uses an adaptive filter for extracting the audio components only. The adaptive filter adjusts its filter coefficients in accordance with a reference input signal that carries the noise components only, to have a smaller error signal.

In the known technique, an amplitude of the main input signal is detected to obtain a gain value that is to be multiplied with the reference input signal that carries the noise components only (a gain control). The gain control makes higher the adaptive speed when the amplitude of the main input signal is small, to remove the noises actively, whereas lower the adaptive speed when the amplitude is large, to suppress the distortion of the input signal.

Also known is an adaptive line enhancer that is a signal-component extraction apparatus using an adaptive filter. The adaptive line spectrum enhancer adjusts filter coefficients to have a smaller difference (error signal) between a desired signal (a delayed input signal) and a filtered signal, to extract signal components of high correlation or signal components of low correlation at different points on the circuitry. Here, the desired signal is obtained by delaying an input signal. The filtered signal is obtained by filtering the input signal with the adaptive filter.

As described above, the adaptive line enhancer is capable of extracting desired signal components from an input signal.

The level of the extracted signal components may, however, not always be a desired level, depending on the level of the input signal. Especially, when an input signal has an extremely small amplitude, the adaptive line spectrum enhancer may reduce desired signal components in addition to undesired components.

In order to solve such a problem, the known technique described above may be applied to the adaptive line enhancer for gain control of the input signal to the adaptive filter. This, however, requires division of a filtered signal by a gain value, which increases the processing load and the complexity of processing circuitry.

### SUMMARY OF THE INVENTION

A purpose of the present invention is to provide a signal-component extraction apparatus and a signal-component extraction method for efficiently and stably extracting desired signal components, with filter coefficients for an adaptive filter to exhibit desired filter characteristics that have almost no effects on anything other than a deriving process of the filter coefficients.

The present invention provides a signal-component extraction apparatus comprising: a delayer configured to delay an input signal to generate a delayed input signal; an adaptive filter configured to adaptively filter the input signal with filter coefficients, to generate a filtered signal; a subtactor configured to subtract the filtered signal from the delayed input signal to generate an error signal; a coefficient controller configured to divide a preset reference value by an amplitude of the input signal to generate a gain value; and a coefficient deriver configured to derive the filter coefficients based on a value obtained by multiplying the input signal and error signal by the gain value.

Moreover, the present invention provides a signal-component extraction method comprising the steps of: delaying an input signal to generate a delayed input signal; adaptively filtering the input signal with filter coefficients, to generate a filtered signal; subtracting the filtered signal from the delayed input signal to generate an error signal; dividing a preset reference value by an amplitude of the input signal to generate a gain value; and deriving the filter coefficients based on a value obtained by multiplying the input signal and error signal by the gain value.

### BRIEF DESCRIPTION OF DRAWINGS

FIG. 1 is a block diagram of a noise reduction apparatus according to a first embodiment of the present invention;

FIG. 2 is a circuit diagram of a coefficient deriver and an adaptive filter;

FIG. 3 is a block diagram of a noise reduction apparatus with gain control of an input signal to be supplied to an adaptive filter;

FIG. 4 is a block diagram for explaining an operation of a coefficient controller and a deriving process of a coefficient deriver;

FIGS. 5A and 5B are block diagrams for explaining another deriving process of a coefficient controller;

FIG. 6 is a flowchart for explaining the steps of a noise reduction method that is one example of a signal-component extraction method, according to a second embodiment of the present invention; and

FIG. 7 is a block diagram of a periodic signal (tone) attenuation apparatus that is a modification to the first embodiment of the present invention.

### DETAILED DESCRIPTION OF PREFERRED EMBODIMENTS

Several preferred embodiments according to the present invention will be described in detail with reference to the drawings.

The same reference signs and numerals are used for the same or analogous components through the drawings in the following disclosure.

Described below is a signal-component extraction apparatus according to the present invention with an adaptive line enhancer. The adaptive line enhancer is an adaptive filter having filter coefficients. The adaptive filter adjusts the filter coefficients in accordance with a signal obtained by delaying an input signal and a filtered signal obtained by filtering the input signal.

Moreover, described below are a noise reduction apparatus and a tone attenuation apparatus as examples of the signal-component extraction apparatus, according to the present invention.

The noise reduction apparatus receives an input signal that carries relatively random noise components, audio components having a relatively regular pattern, and periodic signal components (referred to as tone components, hereinafter) such as a sign wave, mixed one another. Then, the noise reduction apparatus reduces the noise components from the input signal to extract the audio and tone components that are desired signal components.

The tone attenuation apparatus (a beat cancellation apparatus) receives an input signal that carries audio and tone components mixed with each other. Then, the tone attenuation apparatus reduces the tone components to extract the audio components.

### First Embodiment

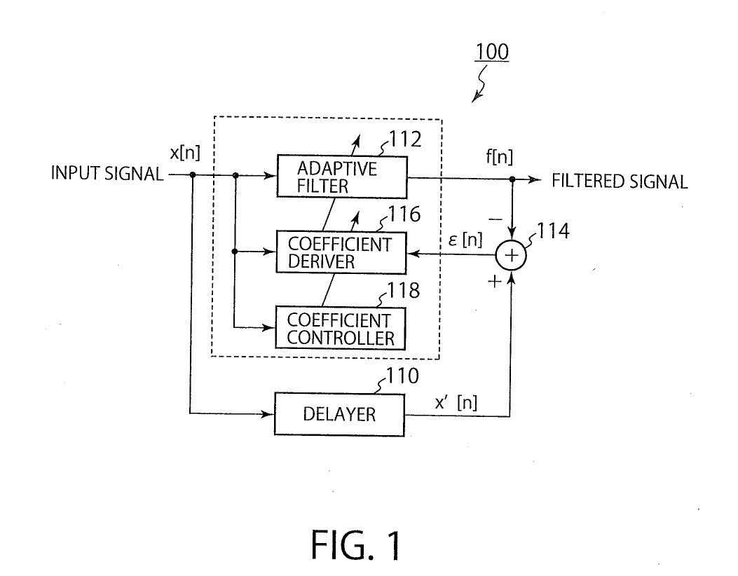

FIG. 1 is a block diagram of a noise reduction apparatus 100 according to a first embodiment of the present invention.

The noise reduction apparatus 100 includes a delayer 110, an adaptive filter 112, a subtractor 114, a coefficient deriver 116, and a coefficient controller 118.

The delayer 110 delays an input signal x[n] (n being an integer that indicates a specific sampling time) to generate a delayed input signal x′[n] that is a desired signal. A delay time of the delayer 110 can be set freely in accordance with the usage of the noise reduction apparatus 100.

The adaptive filter 112 receives the input signal x[n] as a reference input at a left terminal thereof and also an adaptive error signal ε[n] at a terminal indicated by a slanted line that goes through the adaptive filter 112. The adaptive error signal ε[n] is obtained by subtracting a filtered signal from the delayed input signal x′[n], at the subtractor 114, which will be explained later.

The adaptive filter 112 estimates transfer characteristics of the desired signal that is the transfer characteristics of the delayer 110, with filter coefficients that are adjusted any time so as to have a smaller error signal ε[n], which will be explained later. With the estimated transfer characteristics, the adaptive filter 112 adaptively filters the input signal x[n] to generate a filtered signal f[n].

The subtractor 114 subtracts the filtered signal f[n] (the output of the adaptive filter 112) from the delayed input signal x′[n] (the output of the delayer 110) to generate an error signal ε[n] that is a reference input to the coefficient deriver 116 as an adaptive error. Practically, the subtractor 114 adds an inverted signal of the filtered signal f[n] to the delayed input signal x′[n].

The adaptive filter 112 extracts a signal component having relatively high correlation from input signals that are input to the adaptive filter 112 at different timing, in accordance with the transfer characteristics estimated for the delayer 110.

Accordingly, the filtered signal f[n] (the output of the adaptive filter 112) is a signal having relatively high correlation included in the delayed input signal x′[n] (the output of the delayer 110).

Therefore, the subtractor 114 can extract only a signal having relatively low correlation (the error signal ε[n]) included in the delayed input signal x′[n].

The coefficient deriver 116 derives filter coefficients for the adaptive filter 112 so as to have a smaller error signal ε[n], based on the input signal x[n] and the error signal ε[n] as an adaptive error generated by the subtractor 114.

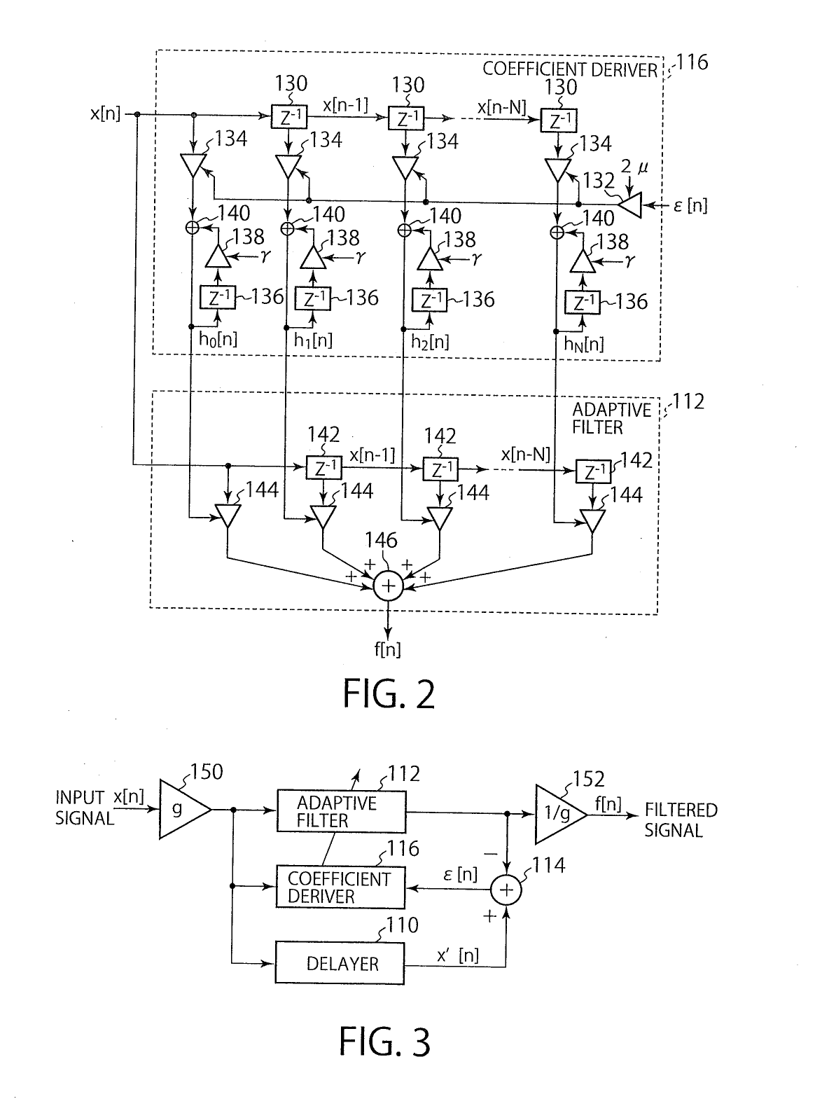

FIG. 2 is a circuit diagram of the adaptive filter 112 and the coefficient deriver 116.

The adaptive filter 112 uses Leaky LMS (Least Mean Square) algorithm that minimizes a mean square error, as an adaptive algorithm.

An equation for updating filter coefficients is expressed as shown below, using an input signal x[n] at a specific sampling time n and an error signal ε[n],

hᵢ[n+1]=γhᵢ[n]+2μ·ε[n]·x[n−i] (1)

where values i and n indicate the order of a filter and a sampling number, respectively. Moreover, a value γ in the equation (1) is a constant larger than 0 but smaller than 1, but closer to 1. In addition, a value μ in the equation (1) is a gain factor for determining adaptive speed and convergence accuracy. These values can be selected appropriately based on statistical characteristics of a reference input signal. The gain factor μ usually takes a value in the range from 0.01 to 0.001, for example.

Operations of the coefficient deriver 116 and the adaptive filter 112 will be described with reference to FIG. 2.

An input signal x[n] is shifted by shift registers 130 at a specific sampling period. The shift registers 130 then generate an input signal string x[n−i] (i=0, 1, . . . , N). The input signal string x[n−i] is supplied to multipliers 134. Also supplied to the multipliers 134 is an error signal ε[n] multiplied by 2μ at a multiplier 132.

The multipliers 134 multiplies the input signal string x[n−i] and the error signal ε[n] multiplied by 2μ to derive the value corresponding to the second term of the right side of the equation (1). The value is then supplied to adders 140.

Filter coefficients hᵢ[n] (i=0, 1, . . . , N) sampled at a previous sampling time and held by registers 136 are multiplied by a value γ at multipliers 138. The result of multiplication at the multipliers 138 is supplied to the adders 140.

The adders 140 adds the result of multiplication at the multipliers 138 and the value corresponding to the second term of the right side of the equation (1) obtained by the multipliers 134, to obtain new or updated filter coefficients hᵢ[n].

The coefficient deriver 116 makes adjustments to have a smaller error signal ε[n] as an adaptive error in accordance with the equation (1), thereby updating the filter coefficients hᵢ[n].

The filter coefficients hᵢ[n] derived by the coefficient deriver 116 as explained above is supplied to the adaptive filter 112 as a reference signal.

The adaptive filter 112 is an FIR (Finite Impulse Response) filter in this embodiment. The adaptive filter 112 receives the filter coefficients hᵢ[n] derived by the coefficient deriver 116 as a reference signal and generates a filtered signal f[n] in accordance with an equation (2) shown below.

$$f [ n ] = {\sum }_{i = 0}^{N} {h}_{i} [ n ] χ [ n - i ] \qquad ( 2 )$$

In operation, the input signal x[n] is shifted by shift registers 142 at a specific sampling period. The shift registers 142 then generate an input signal string x[n−i].

The input signal string x[n−i] generated by the shift registers 142 is then supplied to a (N+1) number of multipliers 144 corresponding the filter length (the number of taps). Also supplied to the multipliers 144 are the filter coefficients hᵢ[n] derived by the coefficient deriver 116. The multipliers 144 convolutes the input signal string x[n−i] with the filter coefficients hᵢ[n].

Values obtained by the convolution at the multipliers 144 are supplied to an adder 146. The adder 146 adds the values to generate a filtered signal f[n].

In FIG. 2, the adaptive filter 112 and the coefficient deriver 116 have the shift registers 142 and 130, respectively. However, either the shift register 130 or 142 may only be provided for both of the adaptive filter 112 and the coefficient deriver 116.

Moreover, in FIG. 2, the adaptive filter 112 uses Leaky LMS (Least Mean Square) algorithm. However, the adaptive filter 112 can use a variety of known algorithms, such as, LMS, RLMS (Recursive LMS), and NLMS (Normalized LMS).

As described with respect to FIG. 2, the transfer characteristics of a desired signal that is the transfer characteristics of the delayer 110 can be estimated by the adaptive filter 112 with the input signal x[n] as a reference input. This means that, an estimation system (the adaptive filter 112) is provided in parallel with the transfer characteristics of the delayer 110 (FIG. 1).

As explained above, the adaptive filter 112 as the adaptive line spectrum enhancer extracts a signal component having relatively high correlation from input signals input to the adaptive filter 112 at different timing, as the filtered signal f[n]. On the other hand, the adaptive filter 112 reduces a signal component having relatively low correlation from these input signals.

Suppose that an input signal x[n] carries desired components (audio and tone components) and noise components mixed with each other. The audio and tone components having relatively high correlation remain as the filtered signal f[n] whereas the noise components having relatively low correlation (or random noise components) are reduced.

Accordingly, the adaptive filter 112 in this embodiment can remove only noise components from an input signal x[n] to enhance audio and tone components at a high S/N ratio.

Notwithstanding, the adaptive filter 112 using the equations (1) and (2) may not always generate a filtered signal f[n] having a desired level that depends on the level of an input signal x[n].

For example, as the amplitude of an input signal x[n] becomes smaller, the amplitude of an error signal ε[n] becomes smaller. This results in that the second term of the right side of the equation (1) becomes almost zero.

Newly derived filter coefficients hᵢ[n+1] are obtained by multiplying the previous filter coefficients hᵢ[n] by a constant γ smaller than 1. Therefore, if the amplitude of an input signal x[n] is continuously small, the filter coefficients hᵢ[n+1] gradually become smaller. The value that is the convergence of the filter coefficients hᵢ[n] thus becomes small. Accordingly, the adaptive filter 112 reduces (attenuates) not only the noise components but also the audio and tone components that are to be extracted.

The adaptive filter 112 often exhibits the attenuation characteristics discussed above for a smaller input signal x[n] than a larger input signal x[n]. That is, the adaptive filter 112 exhibits desired attenuation characteristics for a larger input signal x[n], with almost no attenuation of the amplitude of a filtered signal x[n] to the amplitude of the input signal x[n], for example, −12 dB to −10 dB. On the other hand, the adaptive filter 112 exhibits undesired attenuation characteristics for a smaller input signal x[n], for example, −40 dB to −30 dB.

Such attenuation characteristics tends to appear for algorithms such as Leaky LMS algorithm. In detail, in the equation (1), the second term of the right side is multiplied by the amplitude of an input signal x[n]. This means that the amplitude of the input signal x[n] affects a deriving process of the filter coefficients hᵢ[n] very much. This is not so problematic for an input signal x[n] having an amplitude of narrow range, whereas problematic for an input signal x[n] having an amplitude of wider range in this embodiment.

Therefore, a specific adjustment is required so as to obtain a desired filtered signal f[n]. The adjustment is, for example, gain control of an input signal x[n] before being supplied to the adaptive filter 112.

FIG. 3 is a block diagram of a noise reduction apparatus with gain control of an input signal x[n] to be supplied to the adaptive filter 112.

In FIG. 3, a gain value g of a multiplier 150 is adjusted to be higher for a smaller input signal x[n] to make higher the adaptive speed of the adaptive filter 112 with relatively large filter coefficients hᵢ[n], for obtaining a desired filtered signal f[n] with a relatively large amplitude.

This is, however, still not enough for the noise reduction apparatus 100 (FIG. 1) of this embodiment. In detail, in order to obtain a desired filtered signal f[n] having an amplitude almost the same as that of the input signal x[n], a divider 152 is required at the later stage of the adaptive filter 112. The divider 152 divides the output of the adaptive filter 112 by the value equal to the gain of the multiplier 150 at the same timing as the multiplier 150.

However, division requires a higher computational workload than addition, subtraction, and multiplication. Therefore, the divider 152 increases processing load and makes complex the circuitry of the adaptive filter 112. Moreover, in FIG. 3, the input signal x[n] is multiplied by the gain value g at the multiplier 150 before being supplied to the adaptive filter 112. The gain value g affects an input signal string x[n−1]. The gain value g inevitably affects the input and the output of the adaptive filter 112.

In order to solve such problems discussed above, the present embodiment makes a specific improvement, as explained below. The improvement aims for an input signal x[n] to be supplied to the adaptive filter 112 to affect only an updating process of the filter coefficients hᵢ[n], with no particular processing to the input signal x[n], giving desired filtering characteristics to the adaptive filter 112.

As explained above, the second term of the right side of the equation (1) is multiplied by the amplitude of an input signal string x[n−i] that affects filter coefficients hᵢ[n] hence the adaptive speed of the adaptive filter 112 very much.

In the embodiment, the effects of the input signal string x[n] to the updating process of the filter coefficients hᵢ[n] are diminished to stabilize the adaptive filter 112.

In detail, in FIG. 1, the coefficient controller 118 outputs a gain value g by dividing a predetermined reference value by, for example, a level of an input signal x[n] that is an RMS (Root Mean Square) value.

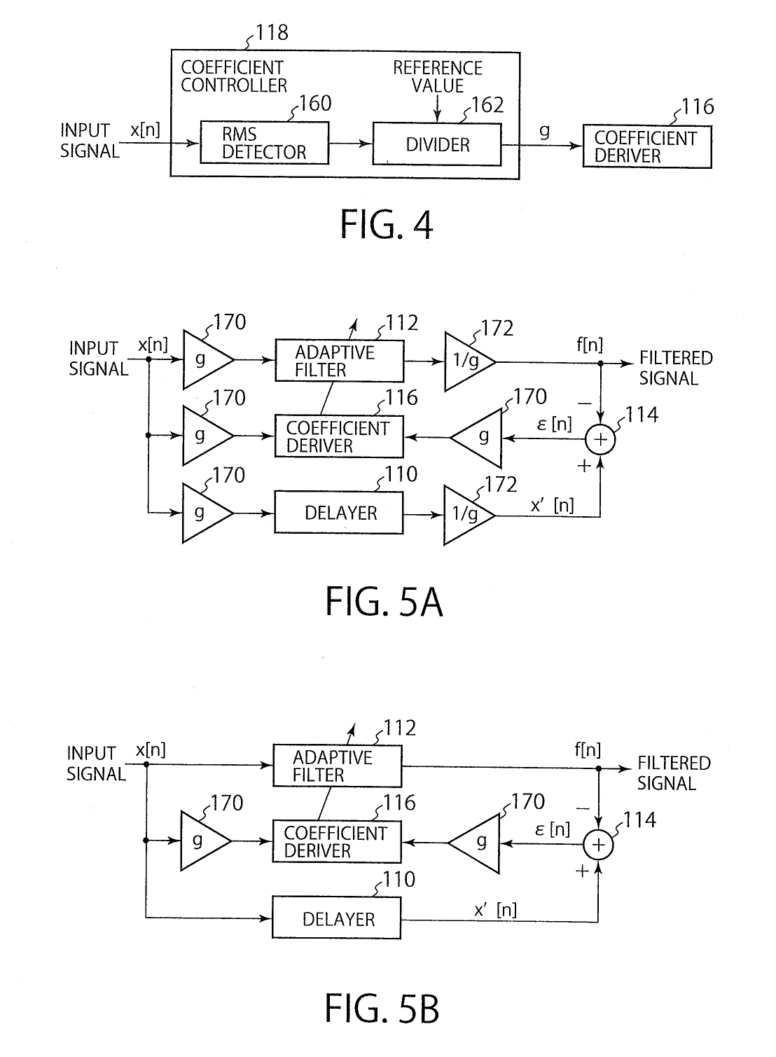

The reference value is determined so that an input signal x[n] is not be attenuated by the adaptive filter 112 so much within the whole range of the amplitude of the input signal x[n] through effective attenuation characteristics. The reference value depends on the usage of the noise reduction apparatus 100 and the constant value γ and the gain factor μ in the equation (1). Once, the reference value is set at the noise reduction apparatus 100, it is always supplied to a divider 162 shown in FIG. 4 which will be described later.

The level of an input signal x[n] by which the reference value is divided for obtaining the gain value g may be any value that expresses the amplitude of the input signal x[n], such as, an averaged value, a value obtained through low-pass filtering, in addition to an RMS value.

FIG. 4 is a block diagram for explaining an operation of the coefficient controller 118 and a deriving process of the coefficient deriver 116.

In FIG. 4, the coefficient controller 118 includes an RMS detector 160 and the divider 162 mentioned above. The RMS detector 160 is, for example, an RMS/dB converter to derive RMS values for input signals x[n] sampled in the range from 100 to 1,000 times to statistically estimate the variation of the amplitude of input signals x[n]. The divider 162 divides a reference value for the adaptive filter 112 to exhibit desired characteristics by an RMS value (reference value/RMS value) to output a gain value g that is then supplied to the coefficient deriver 116.

The coefficient deriver 116 multiplies the gain value g output from the coefficient controller 118 with the second term of the right side of the equation (1). This means that the coefficient deriver 116 multiplies a product of an input signal string x[n−i] and an error signal ε[n] by the gain value g. Through this multiplication, a multiplier 2μ shown in FIG. 2, that is multiplied by the multiplier 132, becomes 2 μg.

Through the procedure described with reference to FIG. 4, filter coefficients hᵢ[n] are adjusted to give the adaptive filter 112 the desired characteristics to the input signal x[n].

Accordingly, the equation (1) for updating filter coefficients hᵢ[n] is expressed as

hᵢ[n+1]=γhᵢ[n]+2μ·g·ε[n]·x[n−i] (3)

When the amplitude of an input signal x[n] continuously takes a small value, an RMS value becomes a small value, and then a gain value g becomes a relatively large value. An input signal string x[n−i] is thus multiplied by a large gain value g in an updating process of filter coefficients hᵢ[n] using the equation (3) at the coefficient driver 116. The average value of x[n−i]×g is more or less equal to the reference value.

On the other hand, when the amplitude of an input signal x[n] continuously takes a large value, an RMS value becomes a large value, and then a gain value g becomes a relatively small value. An input signal string x[n−i] is thus multiplied by a small gain value g in the updating process of filter coefficients hᵢ[n] using the equation (3) at the coefficient driver 116. The average value of x[n−i]×g is also more or less equal to the reference value.

The gain value g is obtained by dividing a reference value by an RMS value of an input signal x[n]. And, the input signal x[n] is multiplied by the gain value g in the equation (3). It appears that the input signal x[n] is cancelled and the result of x[n−i]×g is fixed to a constant reference value.

However, the gain value g is calculated based on an RMS value (an average value of an input signal x[n]). Thus, the change in the gain value g is diminished by the change in the input signal x[n], resulting in that the change in the input signal x[n] is reflected on the equation (3).

Accordingly, by multiplying the input signal x[n] by the gain value g, the sensibility can be diminished if too high to the input signal x[n]. Therefore, a stable noise reduction effect can be achieved with a stable filtered signal f[n], even if the amplitude of the input signal x[n] varies in a wide range.

When the gain value g is supplied to the coefficient deriver 116 from the coefficient controller 118, the gain value g may be multiplied with both of the input signal x[n] and error signal ε[n] to derive filter coefficients hᵢ[n] of the adaptive filter 112. In this case, the equation (1) can be changed to the following equation (4).

hᵢ[n+1]=γhᵢ[n]+2μ·g²·εE[n]·x[n−i] (4)

Another deriving process of the coefficient controller 118 will be described with respect to FIGS. 5A and 5B.

FIG. 5A is a block diagram equivalent to FIG. 3. In FIG. 5A, the multiplier 150 for multiplying an input signal x[n] by a gain value g shown in FIG. 3 is provided before each of the delayer 110, the adaptive filter 112, and the coefficient deriver 116, as a multiplier 170. The provision of the three multipliers 170 requires dividers 172 for division with the gain value g after the delayer 110 and the adaptive filter 112. The dividers 172 bring back a filtered signal f[n] multiplied by the gain value g to a correct scale.

If the multiplier 170 and divider 172 for each of the delayer 110 and adaptive filter 112 are cancelled each other, there are two multipliers 170 remaining to the inputs of the coefficient deriver 116, as shown in FIG. 5B. This means that, if the gain control equivalent to FIG. 3 is performed, it is more effective to multiply a gain value g not only with an input signal string x[n−i] but with an error signal ε[n].

Accordingly, the coefficient controller 118 multiplies a gain value g not only with an input signal string x[n−i] but with an error signal ε[n]. This results in that ε[n]·x[n−i] is multiplied by the square (g²) of the gain value g.

As discussed above, in the updating process of filter coefficients hᵢ[n] in accordance with the Leaky LMS algorithm, the second term of the right side of the equation (1) is affected by an input signal string x[n] very much. In addition, filter coefficients hᵢ[n] are affected by an error signal ε[n] related to a delayed input signal string) x′[n] obtained by delaying the input signal string x[n] very much.

With the deriving process described above with respect to FIGS. 5A and 5B, the effects of an input signal string x[n] and also an error signal ε[n] to the updating process of filter coefficients hᵢ[n] are diminished to more stabilize the adaptive filter 112.

In the noise reduction apparatus 100 described above, an input signal string x[n] is adjusted to give desired filter characteristics that have almost no effects on anything other than the updating process of filter coefficients hᵢ[n]. Therefore, the noise reduction apparatus 100 does not require such divider 152 shown in FIG. 3, hence achieving reduction of processing load and simplification of processing circuitry.

Moreover, in the noise reduction apparatus 100, the gain control is completed by the coefficient deriver 116 and the coefficient controller 118 only. Therefore, the blocks surrounded by a broken line in FIG. 1 can be integrated in a module with inputs of an input signal x[n] and an error signal ε[n], and an output of a filtered signal f[n].

Accordingly, a user can use the module as the noise reduction apparatus 100 and benefit the advantages of the apparatus 100, with no necessity of knowing the detail of the module. Moreover, a user can use the module like known adaptive filters, without regard to interfacing with the outside of it.

The advantages of the noise reduction apparatus 100 explained above are also applied to a tone attenuation apparatus, a second embodiment of the present invention, which will described later.

Moreover, the feature of the noise reduction apparatus 100 lies in the coefficient controller 118, the other parts being the same as the known noise reduction apparatus using an adaptive line enhancer. Therefore, the noise reduction apparatus 100 of the first embodiment achieves stable operation of the adaptive filter 112, with a maximum use of the known technology.

Furthermore, the noise reduction apparatus 100 sets an optimum reference value to obtain desired filter characteristics to an expected range of amplitude of an input signal x[n]. Therefore, the fluctuation of a filtered signal f[n] can be prevented by a stable noise reduction effect discussed above.

Still furthermore, the functions of the noise reduction apparatus 100 can be programmed and run on a computer. A program of those functions can be stored into a computer-readable media, such as a flexible disc, a magnet-optical disc, a ROM, an EPROM, an EEPROM, a CD (Compact Disc), a DVD (Digital Versatile Disc), and a BD (Blu-ray Disc). The program mentioned above is a data processing means described in any language or in any describing method.

### Second Embodiment

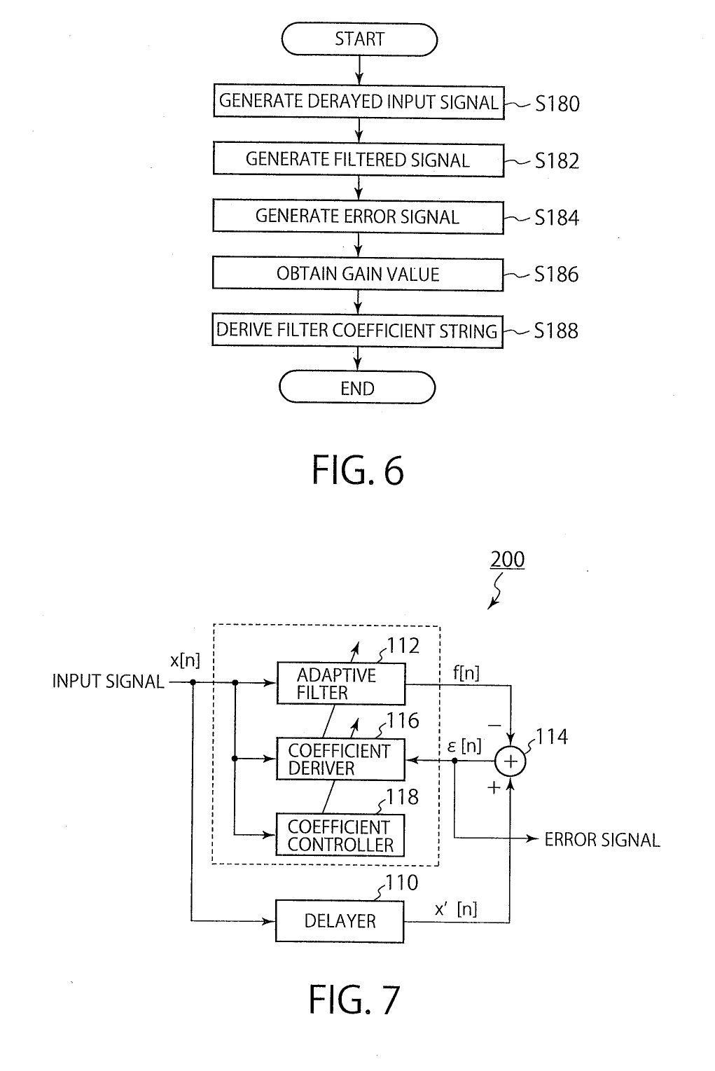

FIG. 6 is a flowchart for explaining the steps of a noise reduction method that is one example of a signal-component extraction method using the noise reduction apparatus 100, according to a second embodiment of the present invention.

A reference value is preset to the coefficient controller 118. Then, an input signal x[n] is delayed by the delayer 110 to generate a delayed input signal x′[n] (step S180).

Filter coefficients hᵢ[n] derived by the coefficient deriver 116 at a previous sampling time are used by the adaptive filter 112 to generate a filtered signal f[n] in accordance with the equation (2) (step S182).

The filtered signal f[n] generated by the adaptive filter 112 is subtracted from the delayed input signal x′[n] by the subtractor 114 to generate an error signal c[n] (step S184).

The preset reference value is divided by an RMS value of the input signal x[n] at the coefficient controller 118 to obtain a gain value g (step S186).

The equation (3) or (4) for deriving filter coefficients hᵢ[n] is used by the coefficient deriver 116 for multiplying the obtained gain value g or the square of the gain value g with an input signal string [n−i] or the error signal ε[n] to derive filter coefficients hᵢ[n] of the adaptive filter 112 (step S188). The derived filter coefficients hᵢ[n] are used in the next sampling time at the adaptive filter 112.

Also in the noise reduction method described above, desired filter characteristics that have almost no effects on anything other than the updating process of filter coefficients hᵢ[n] are derived for effectively and stably extracting desired signal components.

(Modification)

The noise reduction apparatus 100 of the first embodiment extracts, for example, desired components (audio and tone components) while reducing noise components having relatively low correlation, from an input signal x[n] carrying the desired components and the noise components mixed with each other.

In contrast, a tone attenuation apparatus, a modification to the noise reduction apparatus 100, reduces tone components having relatively high correlation to extract audio components from an input signal x[n] carrying the audio and tone components mixed with each other.

In detail, as described with reference to FIG. 1, in the first embodiment, the adaptive filter 112 estimates the transfer characteristics of the delayer 110 for extracting a signal having relatively high correlation from input signals arrived at different timings.

Therefore, the noise reduction apparatus 100 of the first embodiment extracts audio and tone components having relatively high correlation as a filtered signal f[n] among noise, audio and tone components of an input signal x[n]. This results in that an error signal ε[n] carries the noise components without the audio and tone components extracted from the input signal x[n].

When audio and tone components are compared to each other, the tone components having a specific frequency exhibit higher correlation than the audio components. The correlation of tone components is higher than audio components. And, the correlation of audio components is higher than noise components.

Accordingly, a purpose of the modification is to reduce tone components when the tone components are mixed with audio components, as an undesired signal, based on the difference in correlation between the audio and tone components.

If the noise reduction apparatus 100 shown in FIG. 1 is used for reducing tone components, audio components are inevitably reduced through the adaptive filter 112. This is because tone components have higher correlation than audio components.

Accordingly, in the modification, tone components only are extracted by the adaptive filter 112 while audio components are extracted as an error signal ε[n].

FIG. 7 is a block diagram of a tone attenuation apparatus 200 as a modification in the present invention.

The tone attenuation apparatus 200 includes the delayer 110, the adaptive filter 112, the subtractor 114, the coefficient deriver 116, and the coefficient controller 118, the same as those of the noise reduction apparatus 100 shown in FIG. 1.

A difference between the noise reduction apparatus 100 and the tone attenuation apparatus 200 is the output. The noise reduction apparatus 100 outputs a filtered signal f[n]. On the other hand, the tone attenuation apparatus 200 outputs an error signal ε[n].

Another difference between the noise reduction apparatus 100 and the tone attenuation apparatus 200 is an equation for deriving filter coefficients hᵢ[n] due to the difference in cut-off frequency of the adaptive filter 112.

Like the noise reduction apparatus 100, a delayed input signal x′[n] obtained by delaying an input signal x[n] is a desired signal for the adaptive filter 112, in the tone attenuation apparatus 200,

Accordingly, the adaptive filter 112 in which filter coefficients hᵢ[n] converge so as to have a smallest square mean value of an error signal ε[n], reduces audio components while makes periodic tone components remain with no errors.

An error signal ε[n] that is the difference between the desired signal and the filtered signal f[n] caries more audio components due to cancellation of the tone components included in both signals.

As described above, the tone attenuation apparatus 200 outputs the error signal ε[n], thereby obtaining a signal with reduced tone components.

Also in the tone attenuation apparatus 200 and a tone attenuation method (signal-component extraction method) using the apparatus 200, like the first and second embodiments, desired filter characteristics that have almost no effects on anything other than the updating process of filter coefficients hᵢ[n] are derived for effectively and stably extracting desired signal components.

It is further understood by those skilled in the art that the foregoing description is a preferred embodiment of the disclosed apparatus and of the disclosed method and that various changes and modifications may be made in the invention without departing from the spirit and scope thereof.

For example, the noise reduction apparatus 100 and the tone attenuation apparatus 200 can be configured with hardware. Moreover, the functions of the apparatuses and the methods using the apparatuses can be achieved with software. In detail, the apparatuses can be configured with components, such as, digital filters, adders, and subtractors, or analog filters and operational amplifiers. And, the functions of the apparatuses and the methods using the apparatuses can be achieved with programs that run on a computer.

Moreover, the steps of the noise reduction method according to the present invention may not necessarily be performed sequentially as shown in the flowchart of FIG. 6. Furthermore, the steps may include any other processes in parallel or as a subroutine.

As described above in detail, the present invention is applicable to a signal-component extraction apparatus and a signal-component extraction method for extracting a desired signal from an input signal.

When applied to those apparatus and method, the present invention is advantageous in that desired filter characteristics that affects only the updating process of filter coefficients hᵢ[n] can be derived for effectively and stably extracting desired signal components.

What is claimed is:

1. A signal-component extraction apparatus comprising:
a delayer configured to delay an input signal to generate a delayed input signal;
an adaptive filter configured to adaptively filter the input signal with filter coefficients, to generate a filtered signal;
a subtractor configured to subtract the filtered signal from the delayed input signal to generate an error signal;
a coefficient controller configured to divide a preset reference value by an amplitude of the input signal to generate a gain value; and
a coefficient deriver configured to derive the filter coefficients based on a value obtained by multiplying the input signal and error signal by the gain value.

2. The signal-component extraction apparatus according to claim 1, wherein the coefficient deriver derives the filter coefficients based on a value obtained by multiplying the input signal and error signal by a square of the gain value.

3. A signal-component extraction method comprising the steps of:
delaying an input signal to generate a delayed input signal;
adaptively filtering the input signal with filter coefficients, to generate a filtered signal;
subtracting the filtered signal from the delayed input signal to generate an error signal;
dividing a preset reference value by an amplitude of the input signal to generate a gain value; and
deriving the filter coefficients based on a value obtained by multiplying the input signal and error signal by the gain value.

4. The signal-component extraction method according to claim 3, wherein the filter coefficients are derived based on a value obtained by multiplying the input signal and error signal by a square of the gain value.
